(19) United States
(12) Patent Application Publication
(10) Pub. No.: US 2023/0313983 A1
(43) Pub. Date: Oct. 5, 2023

(54) LINEAR LIGHT FIXTURE WITH ENHANCED RESISTANCE TO WATER INGRESS

(71) Applicant: ABL IP Holding LLC, Atlanta, GA (US)

(72) Inventor: Stephen Barry McCane, McDonough, GA (US)

(21) Appl. No.: 18/129,958

(22) Filed: Apr. 3, 2023

Related U.S. Application Data
(60) Provisional application No. 63/327,181, filed on Apr. 4, 2022.

(51) Int. Cl. F21V 31/00

(52) U.S. Cl. CPC F21V 31/005; F21Y 2103/00

(57) ABSTRACT

A light fixture, such as but not limited to an outdoor light fixture, may include features or elements allowing for enhanced resistance to water ingress and/or enhanced thermal management of components. Such features or elements may be provided between a housing of the light fixture and a lens of the light fixture and/or between the housing of the light fixture and an end cap of the light fixture. Some features or elements may limit thermal expansion and contraction of a lens of the light fixture over a wide range of temperatures.

### REFERENCE TO RELATED APPLICATION

This application claims the benefit of U.S. Provisional Patent Application No. 63/327,181, filed on Apr. 4, 2022, and entitled LINEAR LIGHT FIXTURE WITH ENHANCED RESISTANCE TO WATER INGRESS, the content of which is hereby incorporated by reference in its entirety.

### FIELD OF INVENTION

The present technology relates to light fixtures, and more particularly to light fixtures such as but not limited to outdoor light fixtures that may be exposed to water and/or a range of temperatures in use.

### BRIEF SUMMARY OF THE INVENTION

Light fixtures may include elements or features for enhanced resistance of the light fixture to water ingress and/or enhanced thermal management. Such elements or features may include, but are not limited to, sealing members forming an interface between a housing of the light fixture and a lens of the light fixture and/or sealing members forming an interface between the housing and an end cap of the light fixture. In some embodiments, the light fixtures may be particularly useful as outdoor light fixtures, although the embodiments described herein are not limited to outdoor light fixtures.

### BRIEF DESCRIPTION OF THE FIGURES

FIG. 1 is a bottom perspective view of a light fixture according to embodiments.

FIG. 2 is a perspective view of the light fixture of FIG. 1 with an end cap removed.

FIG. 3 is a sectional view of the light fixture of FIG. 1.

FIG. 4 is a sectional view of a portion of the light fixture of FIG. 1.

FIG. 5 is a partial exploded view of a portion of the light fixture of FIG. 1.

FIG. 6 is a perspective view of an end cap of the light fixture of FIG. 1.

FIG. 7 is a perspective view of an end sealing member of the light fixture of FIG. 1.

FIG. 8 is a sectional view of the end sealing member assembled with the end cap of the light fixture of FIG. 1.

FIG. 9 is an end view of the assembled end sealing member and end cap of FIG. 8.

FIG. 10 is a sectional view of a portion of the light fixture of FIG. 1.

### DETAILED DESCRIPTION

Described herein are light fixtures with elements or features allowing for enhanced resistance of the light fixture to water ingress. Additionally, or alternatively, the light fixtures described herein may include elements or features that may limit thermal expansion and contraction of a lens of the light fixture over a wide range of temperatures. In non-limiting examples, the light fixtures described herein may be certified to a temperature range of about −40° C. to about 50° C. In some embodiments, the light fixtures may be particularly useful as outdoor light fixtures, although the embodiments described herein are not limited to outdoor light fixtures. Various other benefits and advantages may be realized with the systems and methods provided herein, and the aforementioned advantages should not be considered limiting.

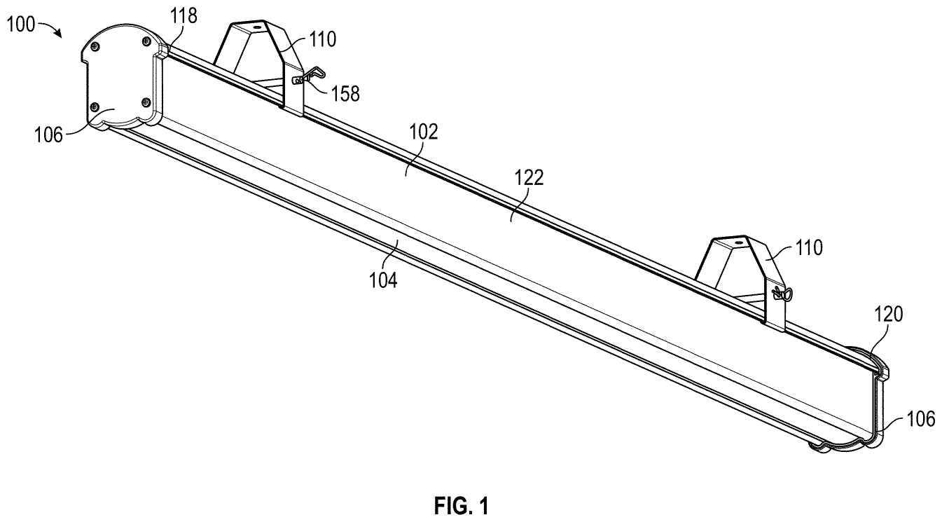

FIGS. 1-10 illustrate an example of a light fixture 100 according to embodiments. The light fixture 100 may be used in various environments or settings as desired. As one non-limiting example, the light fixture 100 may be an outdoor light fixture. The overall light fixture 100 may have various shapes, profiles, and/or sizes as desired, and the features described herein for enhanced resistance to water ingress and/or thermal expansion may be used with other types and/or shapes of light fixtures as desired. As such, while the light fixture 100 is illustrated as a linear light fixture, in other embodiments the light fixture may have a different shape/geometry.

The light fixture 100 generally includes a housing 102, an optic or lens 104, end caps 106, and one or more light sources 108. One or more support structures 110 may be included to facilitate installation and/or support of the light fixture 100 in an environment. Electrical components for the light fixture 100, such as but are not limited to, one or more drivers 112, may be provided within the housing 102 as discussed in detail below.

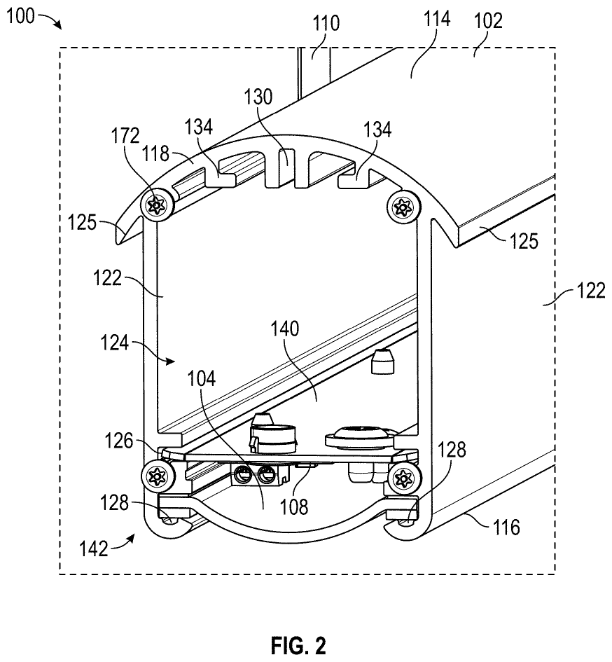

The housing 102 of the light fixture 100 generally includes a top end 114, a bottom end 116, a first end 118, and a second end 120. One or more side walls 122 may extend from top end 114 to the bottom end 116, and the side walls 122 and top end 114 together define a housing area 124 of the housing 102. Various components of the light fixture 100 may be at least partially positioned within the housing area 124. As a non-limiting example, and as illustrated in FIGS. 2-4, the one or more light sources 108, the lens 104, and/or the driver 112 may be at least partially positioned within the housing area 124.

In some embodiments, the housing 102 includes one or more support features facilitating the support of the components within the housing area 124. The support features may include various features or components that facilitate engagement with and/or support by the housing 102. In certain embodiments, the support features may be adhesives, mechanical fasteners, or connectors such as screws, bolts, etc., and/or other features or components. In other embodiments, the support features may be integrally or monolithically formed with the housing 102, and separate fasteners or support features need not be required. As such, while some support features of the housing 102 may facilitate support of various components within the housing area 124 without mechanical fasteners, other support features optionally facilitate support of components using mechanical fasteners.

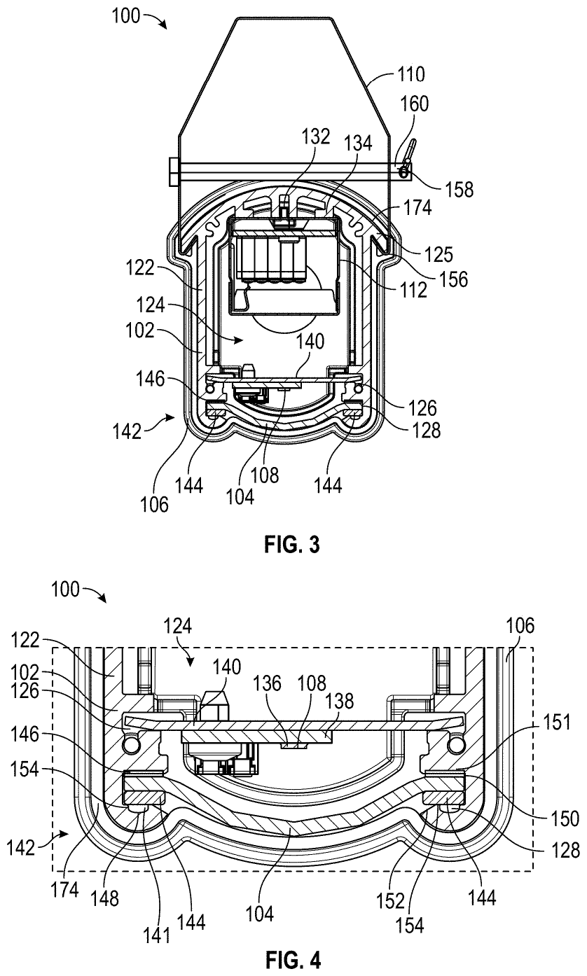

In the embodiment illustrated, the housing 102 includes both integral support features and separate support features. Referring to FIGS. 2-4, in certain embodiments, the support features include first support grooves 126 and/or second support grooves 128 integrally or monolithically formed with the housing 102. In this embodiment, the first support grooves 126 and second support grooves 128 are defined as portions of the side walls 122. The first support grooves 126 may receive and support part of a mounting substrate 140 for the light sources 108, and the second support grooves 128 may receive and support a portion of the lens 104. Other integral support features may be included in addition to or in place of the support grooves 126, 128 as desired. As illustrated in FIGS. 2 and 3, the housing 102 additionally includes an engagement feature 130, such as but not limited to a groove, channel, bore, aperture, etc., that a mechanical fastener 132 may engage to support the driver 112 within the housing area 124. Other support features for engagement with mechanical and/or other separate fasteners may be utilized as desired.

The light sources 108 of the light fixture 100 may include any suitable source of light, including, but not limited to, a light emitting diode (“LED”), an organic LED (“OLED”), an incandescent bulb, combinations thereof, or other sources as desired. In the embodiment illustrated, the light sources 108 include one or more LEDs 136 on one or more printed circuit boards (“PCBs”) 138. In these embodiments, each of the one or more PCBs 138 may have wiring for connecting to the driver 112, which can be shared between PCBs, or each PCB may have its own power supply. The LEDs 136 may be single-die or multi-die LEDs that are powered by direct current (DC) or alternating current (AC) as desired. In various embodiments, the LEDs 136 are organic light emitting diodes. White LEDs, color LEDs, multicolor LEDs, or a combination thereof may be used.

In some embodiments, the light sources 108 optionally are provided on one or more mounting substrates 140 to facilitate positioning of the light sources 108 within the housing area 124. As a non-limiting example, FIGS. 2 and 3 illustrate the mounting substrates 140 at least partially positioned within the first support grooves 126 such that the light source 108 is supported within the housing area 124.

The lens 104, when included, may be supported on the housing 102 to extend over the light sources 108 and control the appearance of light emitted from the light fixture 100. In various embodiments, the lens 104 is supported on the housing 102 to enclose at least the housing area 124 at the bottom end 116 of the housing 102. In certain embodiments, and as best illustrated in FIGS. 2 and 3, at least a portion of the lens 104 may be positioned within the second support grooves 128.

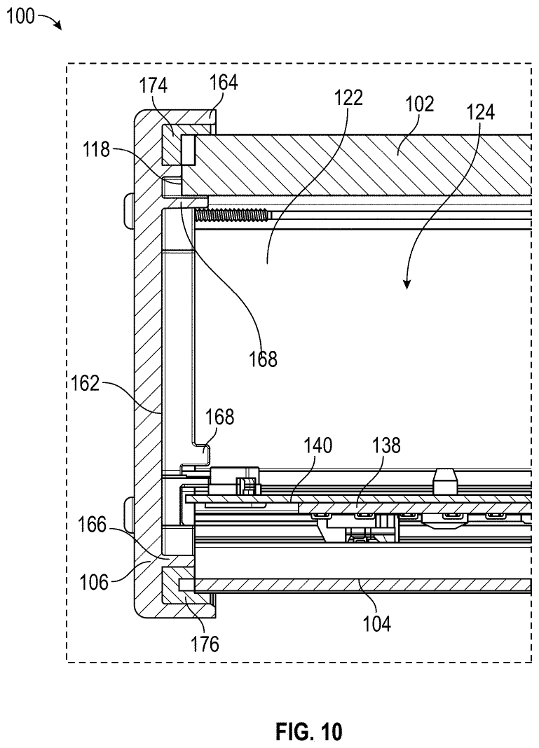

The end caps 106 may be attached to the ends 118, 120 of the housing 102 to further enclose the housing area 124. As best illustrated in FIG. 6, each end cap 106 may include a face 162 having an outer wall 164 and an inner wall 166. In some embodiments, the outer wall 164 and the inner wall 166 each may form a closed perimeter and/or extend continuously. A height of the inner wall 166 may be less than a height of the outer wall 164, although it need not be in other embodiments. As best illustrated in FIG. 10, when the end cap 106 is assembled with the housing 102, the housing 102 may be received between the outer wall 164 and the inner wall 166. In some embodiments, the end caps 106 may include one or more projections 168 that extend from the inner wall 166 to further facilitate positioning of the housing 102 between the walls 164, 166.

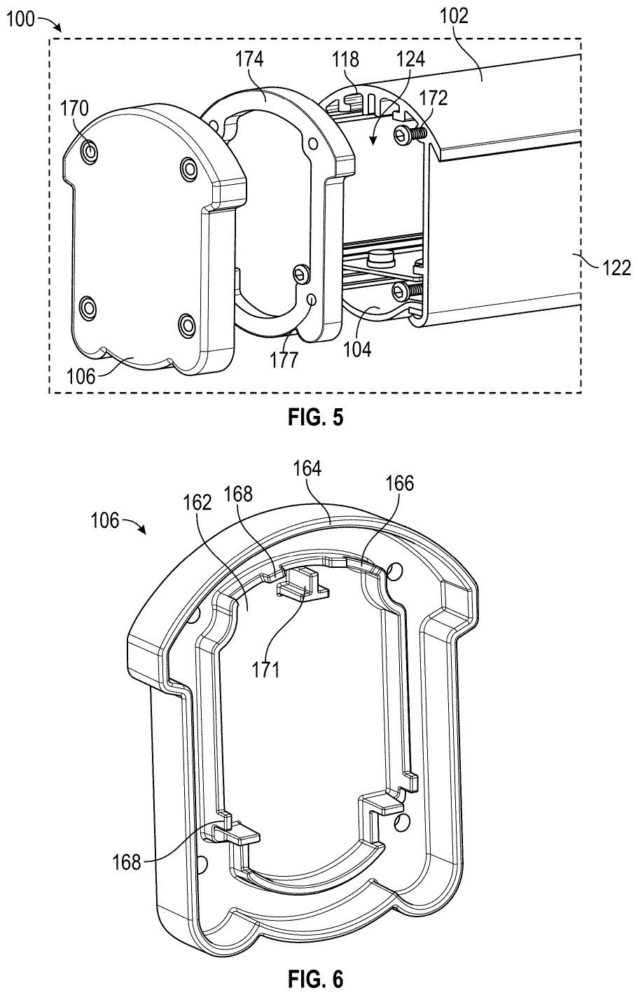

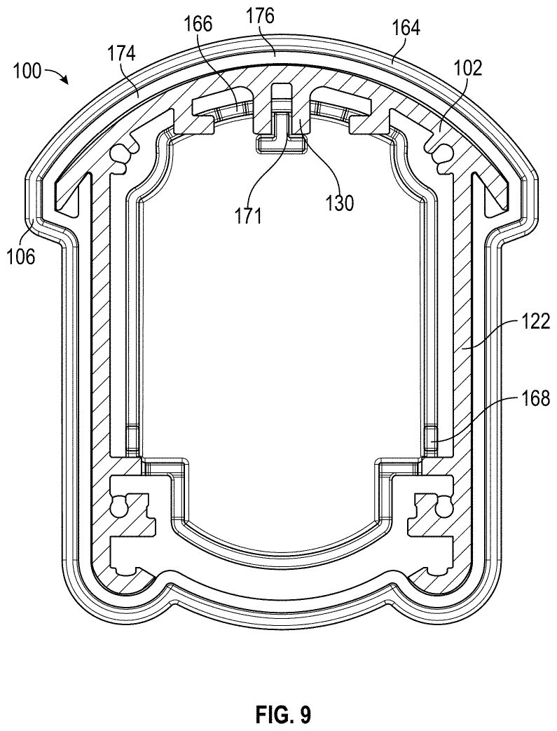

Referring to FIG. 5, one or more apertures 170 optionally may be defined in each end cap 106. In some embodiments, the apertures 170 may receive mechanical fasteners 172 for connecting the end cap 106 to the housing 102. However, in other embodiments, other features or techniques may be used to attach the end caps 106 to the housing 102 as desired in place of or in addition to the mechanical fasteners 172 and apertures 170. As a non-limiting example, and as illustrated in FIGS. 6 and 9, for example, the end cap 106 may include a projection 171 extending outwards from the face 162 and that is positionable at least partially in the engagement feature 130. Such engagement between the projection 171 and the engagement feature 130 may further position the end cap 106 relative to the housing 102. Optionally, the projection 171 extends outwards from the face 162 within a perimeter of the inner wall 166, although it need not in other embodiments and instead may be provided at other locations on the end cap 106. Moreover, the shape of the projection 171 should not be considered limiting. Other features or techniques may include, but are not limited to, snap-fit engagement features, friction fit features, other mechanical fasteners, combinations thereof, and/or other features as desired.

As discussed in greater detail below, the light fixture 100 may include various features for improved thermal management and/or resistance to water ingress.

### Thermal Management

In various embodiments, the light fixture 100 includes features for improved thermal management of the various components of the light fixture 100.

In some embodiments, the thermal management features may include features on the housing 102 for improved thermal management for the components within the housing area 124. As a non-limiting example, and referring to FIGS. 2 and 3, the housing 102 may include one or more fins 134 that contact a surface of the driver 112 (or other electronics within the housing area 124) when the driver 112 is supported within housing 102. In these embodiments, the fins 134 may increase the surface contact with the driver 112, thereby allowing for an increased heat flow away from the driver 112 via the fins 134 and an improved regulation of the temperature of the driver 112. Optionally, the engagement feature 130 may further provide thermal management by contacting the surface of the driver 112, thereby allowing for additional heat flow away from the driver 112. In other embodiments, other thermal management features may be used in addition to or in place of the fins 134 and/or the engagement feature 130 as desired.

Additionally, or alternatively, the thermal management features may include features for positioning the lens 104. Referring to FIG. 4, in some embodiments, the light fixture 100 includes a bottom member 144 and optionally a top member 146 within each second support groove 128.

The bottom member 144 may be constructed from or include a durable, compressible material for positioning the lens 104 within the second support grooves 128. One non-limiting example of a durable, compressible material for the bottom member 144 is durable rubber (DR) acrylic, which may be in a strip or other form. Other durable, compressible materials for sealing and positioning the lens 104 may be utilized as desired.

The top member 146 may be gasket tape (e.g., with adhesive backing) for further positioning of the lens 104 within the second support grooves 128. In other embodiments, the top member 146 may be other materials or devices for sealing and positioning the lens 104 and need not be gasket tape.

Referring to FIG. 4, each bottom member 144 may be provided within the second support grooves 128 between the lens 104 and bottom portions 148 of the second support grooves 128. Each top member 146 may be provided within the second support grooves 128 between the lens 104 and top portions 150 of the second support grooves 128. In various embodiments, an end 152 of the bottom portion 148 of each second support groove 128 may optionally extend at an angle (e.g., oblique angle or otherwise in a non-parallel direction) relative to a horizontal axis or direction to facilitate positioning of the bottom members 144 within the second support grooves 128. The bottom portion 148 of each second support groove 128 optionally may also include one or more ribs 154 to further facilitate positioning and supporting the bottom members 144 within the grooves 128. In some embodiments, and as illustrated in FIG. 4, for example, the support groove 128 may include at least two ribs 154—one on an edge of the end 152 of the bottom portion 148 and another at an intermediate location on the bottom portion 148. In this embodiment, the ribs 154 together may contact the bottom member 144 for positioning the bottom member 144 against the lens 104.

The bottom members 144 may support and position the lens 104 relative to the housing 102, thereby providing a more secure and stable light fixture 100. In various embodiments, the support and positioning of the lens 104 by the bottom members 144 may also help to limit thermal expansion and contraction of the lens 104 in the light fixture 100 over a wide temperature range. As a non-limiting example, in some embodiments, the bottom members 144 may limit expansion and contraction of the lens 104 over a temperature range such as but not limited to from about −40° C. to about 50° C. As a non-limiting example, in embodiments the lens 104 positioned by the bottom members 144 may contract about 0.200 inches over a temperature range of −40° C. to about 50° C. However, the above examples should not be considered limiting, and other improvements to minimize thermal expansion may be realized with the fixtures described herein.

### Water Ingress Management

The light fixture 100 may include various features for minimizing and/or preventing water ingress into the light fixture 100.

In some embodiments, water ingress management features may include a shape or profile of the housing 102. Referring to FIG. 2, in some embodiments, the top end 114 of the housing 102 may have a non-linear profile in a horizontal direction. In these embodiments, the non-linear profile of the top end 114 may facilitate or encourage water contacting the top end 114 (e.g., when it rains) to flow or otherwise move off the light fixture 100. In the embodiment illustrated, the top end 114 is arcuate-shaped; however, in other embodiments, the top end 114 may have various other geometries, shapes, or profiles as desired that facilitate or encourage water to flow or otherwise move off the light fixture 100.

Optionally, the top end 114 includes overhang portions 125 that extend outwards relative to the side walls 122. The overhang portions 125 may further facilitate or encourage water to flow or otherwise move off the light fixture 100 at locations offset from the side walls 122. In some embodiments, the overhang portions 125 may define mounting or attachment locations that can engage the support structures 110. For example, and as best shown in FIG. 3, the support structures 110 may include brackets with hook portions 156 that engage the overhang portions 125. The support structures 110 optionally may include a locking feature 158, such as but not limited to a clevis pin 160, for locking the support structures 110 on the overhang portions 125. When used, the locking feature 158 can hinder and/or prevent unintentional disengagement of the support structures 110 from the housing (e.g., by limiting outward movement of the support structures 110). While the illustrated support structures 110 are particularly useful, other types of support structures 110 may be used with the housing 102 as desired for facilitating support of the light fixture 100 in a particular environment.

In various embodiments, water ingress management features may include a water sealing system 142 for sealing the portions of the lens 104 within the second support grooves 128, thereby improving the light fixture's resistance to water ingress compared to light fixtures without such water sealing systems. In some embodiments, the water sealing system 142 includes the bottom members 144 and optionally the top members 146. In these embodiments, the bottom members 144 and/or the top members 146 may be constructed from various materials for both sealing and positioning the lens 104. As a non-limiting example, the bottom member 144 constructed from DR acrylic may both seal and position the lens 104, although other durable and compressible materials may be utilized as desired.

Referring to FIG. 4, the bottom members 144 within the second support grooves 128 may engage both the bottom portions 148 of the second support grooves 128 and the lens 104 to form a seal that hinders and/or prevents water ingress into the housing area 124. As mentioned, the bottom members 144 may also support and position the lens 104 relative to the housing 102, thereby providing a more secure and stable light fixture 100. Optionally, a gap 141 may be defined between the bottom member 144 and the bottom portion 148 when the bottom member 144 is contacted by the ribs 154, and the gap 141 may provide further protection against water ingress. Similar to the bottom members 144, the top members 146 within the second support grooves 128 may engage top portions 151 of the second support grooves 128 and the lens 104 to further form a seal between the lens 104 and the housing 102. In other embodiments, the top members 146 need not form a seal, and the seal formed by the bottom members 144 may provide sufficient sealing against water ingress. Other improvements to minimize water ingress may be realized with the fixtures described herein.

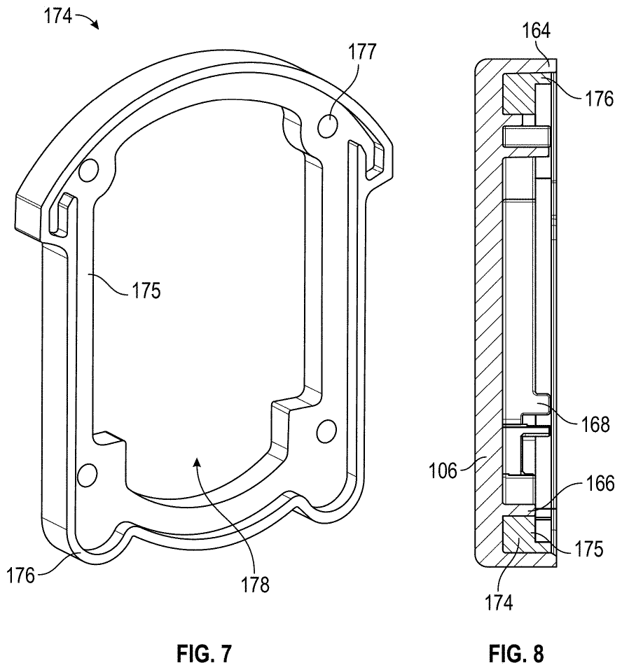

In various embodiments, water ingress management features may be provided with the end caps 106. Referring to FIGS. 5-10, in some embodiments, end sealing members 174 may be provided with each end cap 106 to further improve resistance of the light fixture 100 to water ingress. Referring to FIG. 7, each end sealing member 174 may include a body 175 and an outer wall 176, and the body 175 defines a central aperture 178. As illustrated in FIG. 8, for example, the end sealing member 174 may be positioned between the walls 164, 166 of the corresponding end cap 106. In some embodiments, and referring to FIG. 8, a height of the body 175 may be substantially the same as the height of the inner wall 166 and a height of the outer wall 176 may be less than the height of the outer wall 164, although they need not be in other embodiments. Optionally, the body 175 may include one or more apertures 177 (see, e.g., FIG. 5) corresponding to the one or more apertures 170 for receiving mechanical fasteners 172 that connect the end cap 106 to the housing 102.

As best illustrated in FIGS. 9 and 10, when the end caps 106 and end sealing members 174 are assembled with the housing 102, the end sealing member 174 may be positioned between the end of the housing 102 and the face 162 of the end cap 106. In various embodiments, the outer wall 176 of the end sealing member 174 is positioned between the housing 102 and the outer wall 164 of the end cap 106. The housing 102 may be positioned between the outer wall 176 of the end sealing member 174 and the projections 168. Such positioning of the end sealing members 174 relative to the housing 102 and the end caps 106 may form a seal around a perimeter of the housing 102 at the ends 118, 120 of the housing 102, thereby increasing the resistance to water ingress by the light fixture 100.

The aforementioned examples are for illustrative purposes, and light fixtures according to the disclosure may have various combinations of thermal management features and/or water ingress management features as desired.

A collection of exemplary embodiments is provided below, including at least some explicitly enumerated as “Embodiments” providing additional description of a variety of example embodiments in accordance with the concepts described herein. These embodiments are not meant to be mutually exclusive, exhaustive, or restrictive; and the disclosure not limited to these example embodiments but rather encompasses all possible modifications and variations within the scope of the issued claims and their equivalents.
Embodiment 1. A light fixture comprising: a housing defining a housing area and comprising a support groove within the housing area; at least one light source within the housing area; a lens at least partially positioned within the support groove and covering the at least one light source; and a sealing member positioned within the support groove and between the lens and a bottom portion of the support groove, wherein the sealing member positions the lens relative to the housing and forms a seal against water ingress.
Embodiment 2. The light fixture of any of the preceding or subsequent embodiments or combination of embodiments, wherein the sealing member comprises a durable rubber acrylic.
Embodiment 3. The light fixture of any of the preceding or subsequent embodiments or combination of embodiments, wherein the sealing member is a bottom sealing member, and wherein the light fixture further comprises a top sealing member within the support groove between the lens and a top portion of the support groove.
Embodiment 4. The light fixture of any of the preceding or subsequent embodiments or combination of embodiments, wherein the top sealing member comprises a gasket tape.
Embodiment 5. The light fixture of claim 1, wherein the housing comprises a top end, a first side wall, and a second side wall, and wherein the support groove is defined in the first side wall opposite from the top end of the housing.
Embodiment 6. The light fixture of any of the preceding or subsequent embodiments or combination of embodiments, wherein the support groove is a first support groove, and wherein the housing further comprises a second support groove defined in the second side wall within the housing area and opposite from the first support groove.
Embodiment 7. The light fixture of any of the preceding or subsequent embodiments or combination of embodiments, wherein an end of the bottom portion of the support groove extends at an oblique angle relative to a horizontal axis.
Embodiment 8. The light fixture of any of the preceding or subsequent embodiments or combination of embodiments, wherein the housing comprises a sidewall, wherein the support groove is a first support groove on the sidewall, and wherein the housing further comprises a second support groove on the sidewall configured to support a mounting substrate for the at least one light source.
Embodiment 9. The light fixture of any of the preceding or subsequent embodiments or combination of embodiments, wherein the bottom portion of the support groove comprises at least two ribs for positioning the sealing member against the lens.
Embodiment 10. The light fixture of any of the preceding or subsequent embodiments or combination of embodiments, further comprising: an end cap attached to a first end of the housing, the end cap comprising a face with an outer wall and an inner wall; and a sealing member between the inner wall and the outer wall and between the face and the first end of the housing, the sealing member forming a seal against water ingress.
Embodiment 11. A light fixture comprising: a housing comprising a first end and a second end, the housing defining a housing area; a light source within the housing area; an end cap attached to the first end of the housing, the end cap comprising a face with an outer wall and an inner wall; and a sealing member between the inner wall and the outer wall and between the face and the first end of the housing, the sealing member forming a seal against water ingress.
Embodiment 12. The light fixture of any of the preceding or subsequent embodiments or combination of embodiments, wherein a height of the inner wall is less than a height of the outer wall.
Embodiment 13. The light fixture of any of the preceding or subsequent embodiments or combination of embodiments, wherein the first end of the housing is positioned between the outer wall and the inner wall of the end cap.
Embodiment 14. The light fixture of any of the preceding or subsequent embodiments or combination of embodiments, wherein the end cap further comprises a plurality of projections extending from the inner wall, the plurality of projections configured to position the first end of the housing between the outer wall and the inner wall of the end cap.
Embodiment 15. The light fixture of any of the preceding or subsequent embodiments or combination of embodiments, wherein housing further comprises a top end, a first sidewall, and a second sidewall, each extending from the first end to the second end of the housing, wherein the top end comprises a non-linear profile.
Embodiment 16. The light fixture of any of the preceding or subsequent embodiments or combination of embodiments, wherein the top end of the housing further comprises an engagement feature extending into the housing area, and wherein the end cap further comprises a projection extending from the face and configured to engage the engagement feature of the top end of the housing within the housing area.
Embodiment 17. The light fixture of any of the preceding or subsequent embodiments or combination of embodiments, wherein the top end of the housing further comprises at least one fin extending into the housing area and configured to contact a surface of a driver positioned within the housing area.
Embodiment 18. The light fixture of any of the preceding or subsequent embodiments or combination of embodiments, wherein housing further comprises a top end, a first sidewall, and a second sidewall, each extending from the first end to the second end of the housing, wherein the sealing member is a first sealing member, wherein the housing further comprises a support groove on the first sidewall within the housing area, and wherein the light fixture further comprises: a lens at least partially positioned within the support groove and covering the at least one light source; and a second sealing member positioned within the support groove and between the lens and a bottom portion of the support groove, wherein the sealing member positions the lens relative to the housing and forms a seal against water ingress.
Embodiment 19. The light fixture of any of the preceding or subsequent embodiments or combination of embodiments, wherein the sealing member is a first sealing member and the end cap is a first end cap, and wherein the light fixture further comprises: a second end cap at the second end of the housing; a second sealing member between the second end cap and the second end of the housing and forming a seal against water ingress at the second end of the housing; a lens supported at a bottom end of the housing; and a third sealing member between the lens and a portion of the housing, the third sealing member forming a seal against water ingress at the bottom end of the housing.
Embodiment 20. The light fixture of any of the preceding or subsequent embodiments or combination of embodiments, wherein the sealing member comprises a body and an outer wall, wherein the body defines a central aperture, and wherein the outer wall of the sealing member is positioned against the outer wall of the end cap.

The various aspects, embodiments, implementations or features of the described embodiments can be used separately or in any combination. In particular, it should be appreciated that the various elements of concepts from the figures may be combined without departing from the spirit or scope of the invention.

Throughout this description for the purposes of explanation, numerous specific details are set forth to provide a thorough understanding of the many aspects and embodiments disclosed herein. It will be apparent, however, to one skilled in the art that the many aspects and embodiments may be practiced without some of these specific details. In other instances, known structures and devices are shown in diagram or schematic form to avoid obscuring the underlying principles of the described aspects and embodiments.

The use of the terms “a” and “an” and “the” and similar referents in the context of describing the invention (especially in the context of the following claims) are to be construed to cover both the singular and the plural, unless otherwise indicated herein or clearly contradicted by context. Directional references such as “up,” “down,” “top,” “bottom,” “left,” “right,” “front,” and “back,” among others, are intended to refer to the orientation as illustrated and described in the figure (or figures) to which the components and directions are referencing. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have the same overall result as if absolute and total completion were obtained. As used herein, the term “about” refers to +/−5% of an indicated value or endpoints of an indicated range.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A light fixture comprising:
a housing defining a housing area and comprising a support groove within the housing area;
at least one light source within the housing area;
a lens at least partially positioned within the support groove and covering the at least one light source; and
a sealing member positioned within the support groove and between the lens and a bottom portion of the support groove, wherein the sealing member positions the lens relative to the housing and forms a seal against water ingress.

2. The light fixture of claim 1, wherein the sealing member comprises a durable rubber acrylic.

3. The light fixture of claim 1, wherein the sealing member is a bottom sealing member, and wherein the light fixture further comprises a top sealing member within the support groove between the lens and a top portion of the support groove.

4. The light fixture of claim 3, wherein the top sealing member comprises a gasket tape.

5. The light fixture of claim 1, wherein the housing comprises a top end, a first side wall, and a second side wall, and wherein the support groove is defined in the first side wall opposite from the top end of the housing.

6. The light fixture of claim 5, wherein the support groove is a first support groove, and wherein the housing further comprises a second support groove defined in the second side wall within the housing area and opposite from the first support groove.

7. The light fixture of claim 1, wherein an end of the bottom portion of the support groove extends at an oblique angle relative to a horizontal axis.

8. The light fixture of claim 1, wherein the housing comprises a sidewall, wherein the support groove is a first support groove on the sidewall, and wherein the housing further comprises a second support groove on the sidewall configured to support a mounting substrate for the at least one light source.

9. The light fixture of claim 1, wherein the bottom portion of the support groove comprises at least two ribs for positioning the sealing member against the lens.

10. The light fixture of claim 1, further comprising:
an end cap attached to a first end of the housing, the end cap comprising a face with an outer wall and an inner wall; and
a sealing member between the inner wall and the outer wall and between the face and the first end of the housing, the sealing member forming a seal against water ingress.

11. A light fixture comprising:
a housing comprising a first end and a second end, the housing defining a housing area;
a light source within the housing area;
an end cap attached to the first end of the housing, the end cap comprising a face with an outer wall and an inner wall; and
a sealing member between the inner wall and the outer wall and between the face and the first end of the housing, the sealing member forming a seal against water ingress.

12. The light fixture of claim 11, wherein a height of the inner wall is less than a height of the outer wall.

13. The light fixture of claim 11, wherein the first end of the housing is positioned between the outer wall and the inner wall of the end cap.

14. The light fixture of claim 13, wherein the end cap further comprises a plurality of projections extending from the inner wall, the plurality of projections configured to position the first end of the housing between the outer wall and the inner wall of the end cap.

15. The light fixture of claim 1, wherein housing further comprises a top end, a first sidewall, and a second sidewall, each extending from the first end to the second end of the housing, wherein the top end comprises a non-linear profile.

16. The light fixture of claim 15, wherein the top end of the housing further comprises an engagement feature extending into the housing area, and wherein the end cap further comprises a projection extending from the face and configured to engage the engagement feature of the top end of the housing within the housing area.

17. The light fixture of claim 15, wherein the top end of the housing further comprises at least one fin extending into the housing area and configured to contact a surface of a driver positioned within the housing area.

18. The light fixture of claim 11, wherein housing further comprises a top end, a first sidewall, and a second sidewall, each extending from the first end to the second end of the housing, wherein the sealing member is a first sealing member, wherein the housing further comprises a support groove on the first sidewall within the housing area, and wherein the light fixture further comprises:
a lens at least partially positioned within the support groove and covering the at least one light source; and
a second sealing member positioned within the support groove and between the lens and a bottom portion of the support groove, wherein the sealing member positions the lens relative to the housing and forms a seal against water ingress.

19. The light fixture of claim 11, wherein the sealing member is a first sealing member and the end cap is a first end cap, and wherein the light fixture further comprises:
a second end cap at the second end of the housing;
a second sealing member between the second end cap and the second end of the housing and forming a seal against water ingress at the second end of the housing;
a lens supported at a bottom end of the housing; and
a third sealing member between the lens and a portion of the housing, the third sealing member forming a seal against water ingress at the bottom end of the housing.

20. The light fixture of claim 11, wherein the sealing member comprises a body and an outer wall, wherein the body defines a central aperture, and wherein the outer wall of the sealing member is positioned against the outer wall of the end cap.
